(19) United States
(12) Patent Application Publication
(10) Pub. No.: US 2002/0168010 A1
(43) Pub. Date: Nov. 14, 2002

(54) System and method for efficient automatic design and tuning of video processing systems

(75) Inventor: Walid S. Ibrahim Ali, Ossinning, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N. V.

(21) Appl. No.: 10/100,596

(22) Filed: Mar. 18, 2002

Related U.S. Application Data
(60) Provisional application No. 60/290,506, filed on May 11, 2001.

(51) Int. Cl. H04N 7/12

(52) U.S. Cl. 375/240.26

(57) ABSTRACT

For use in a video processing system that is capable of processing a video stream using a chain of video-processing algorithms, a system and method for performing automatic design and tuning in an efficient manner using hybrid heuristic optimization methods. In one aspect, the present invention is a method of tuning a video processing system including the steps of applying a genetic algorithm, monitoring the level of solution convergence, determining that the convergence level has satisfied a predetermined convergence-level criterion, and applying a second, more efficient search methodology when the convergence-level criterium has been satisfied to converge on the best local solution. This process is repeated until a best solution is found, and the video processing algorithms are adjusted accordingly. The video processing system iteratively converges toward control parameter configurations that produce a very high quality video image. In another aspect, the present invention is a processed signal produced according to this method.

### RELATED INVENTIONS—CLAIM OF PRIORITY

The patent application is related to and claims benefit of the filing date of United State Provisional Patent Application Serial No. 60/290,506, filed May 11, 2001 by Ali, entitled “Speeding-Up Automatic Design and Tuning of the Video Processing Systems by Using Hybrid Heuristic Optimizers”.

This patent invention is related to that disclosed in U.S. patent application Ser. No. 09/734,823 filed Dec. 12, ,2000 by Ali et al. entitled “System and Method for Providing a Scalable Dynamic Objective Metric for Automatic Video Quality Evaluation” and Ser. No. 09/817,981 filed Mar. 27, 2001, by Ali, et al, entitled “System and Method for Optimizing Control Parameter Settings in a Chain of Video-processing algorithms”. The related patent applications are commonly assigned to the assignee of the present invention.

The disclosures of these related patent applications are hereby incorporated by reference in the present patent application as if fully set forth herein.

### TECHNICAL FIELD OF THE INVENTION

The present invention is directed, in general, to video processing systems that are capable of processing video streams using a chain of video-processing algorithms and, more specifically, to a system and method for speeding up the automatic design and tuning of the video processing systems by using hybrid heuristic optimizers in order to provide a high quality video image.

### BACKGROUND OF THE INVENTION

Video experts continually seek to develop new and improved video processing techniques for improving the quality of video images. The primary goal is to convert a received electronic video signal into a quality video image for presentation to the viewer. In any video processing system, one or more video-processing algorithms are applied to a video stream to modify its characteristics in an attempt to obtain the highest level of video quality.

For example, in a television set, a video signal stream may be processed by a number of video functions. These video functions may include sharpness enhancement, noise reduction, color correction, and other similar video image processing techniques. Each video function may have one or more control parameters that must be set to particular values. The values of the control parameter settings affect the quality of the video image. Furthermore, the order in which the various video functions are applied may also affect the quality of the video image.

As video systems are developed, new types of video-processing algorithms are constantly being introduced. In addition, older types of video-processing algorithms are constantly being refined. Performance capabilities of the various video-processing algorithms tend to increase over time. Not unexpectedly, the implementation complexity of video-processing algorithms also tends to increase over time.

Video-processing algorithms are usually developed and evaluated in isolation from the video processing systems in which they will ultimately be used. After evaluation, the individual video-processing algorithms are combined in a video processing system such as a television, set-top box, or other type of consumer product.

The final video image quality obtainable by a chain of video-processing algorithms in a video processing system strongly depends on the interaction of all of the various constituent video-processing algorithms. This interaction depends on the control parameter settings for each algorithm, the amount of data being transferred between sequential algorithms as well as the order of the sequential algorithms in the video processing chain. Ad hoc methods have long been available to determine the best control parameter settings for a sequence of video-processing algorithms. The currently available ad hoc methods for optimizing the overall video image quality, however, can be very time and computer-resource consuming. Conservation of computing resources is especially important in the case of relatively inexpensive standalone products. Consumer products like televisions simply do not have available to them the video processing capability that would be present at, for example, a large manufacturing facility or college campus. Nor could such capability be provided at reasonable cost. Yet consumers who have grown accustomed to the high-quality video images that can be obtained with even modest television products are constantly expecting quality improvements, and may well base purchasing decisions solely on the best picture quality obtainable for a given price.

There is therefore a need in the art for a system and method that will provide a thorough but efficient analysis of the interaction of video-processing algorithms in a chain of videoprocessing algorithms. The system and method of the present invention provide just such a solution.

### SUMMRY OF THE INVENTION

To address the above-discussed deficiencies of the prior art, the system and method of the present invention provides an efficient automated procedure for efficiently optimizing control parameter settings in video-processing algorithms in order to obtain a very high level of video image quality.

The video processing system of the present invention comprises a chain of video-processing algorithms, an optimization unit, and an objective quality metric unit. An output video stream from the chain of video processing units is fed back to the objective quality metric unit. The objective quality metric unit calculates a fitness value and provides the fitness value to the optimization unit. The optimization unit uses the fitness value to configure the control parameter settings for the video-processing algorithms by first applying a genetic algorithm search method until solution improvement falls below a predetermined convergence level. A more efficient heuristic methodology is then applied to find a local optimum from the genetic-algorithm solution. When a local optimum is found, it is fed back into the genetic algorithm, which is applied again, but this time with the benefit of the local optimum found by the heuristic algorithm. The process continues until a best solution is found. The video processing system iteratively converges toward control parameter configurations that produce a very high quality video image.

In another aspect, the present invention is a video signal produced by applying a chain of video-processing algorithms according to parameters automatically set by an optimization unit having a genetic algorithm and a heuristic algorithm that cooperate to efficiently optimize the parameters. In a preferred embodiment, the genetic algorithm searches until a predetermined convergence level is reached, at which time a microcontroller directs the heuristic algorithm to search for a local optimum. When found, the local optimum may be used by the genetic algorithm for further searching.

It is an object of the present invention to provide a system and method for efficiently configuring video-processing algorithms in order to provide a high quality video image.

It is also an object of the present invention to provide a combination of an objective quality metric unit and an optimization unit for optimizing control parameter settings in video-processing algorithms.

It is another object of the present invention to provide a system and method for speeding up the automatic design and tuning of video processing systems that comprise a plurality of chains of video-processing algorithms.

Note, however, that while it is an object of the present invention to increase the speed and efficiency of the video signal processing system tuning and design, actually achieving this result is not, of itself, a requirement of the claimed invention.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a block diagram of an exemplary video processing system for configuring a chain of video-processing algorithms using the system and method of the present invention;

FIG. 2 illustrates a block diagram of a chain of four video-processing algorithms comprising a spatial scaling algorithm, a histogram modification algorithm, an adaptive peaking algorithm, and a noise reduction algorithm;

FIG. 3 illustrates a block diagram of a video processing chromosome of the present invention comprising a function order gene, a bit precision gene, a noise reduction parameter gene, and a peaking parameter gene; and

FIG. 4 depicts a flow diagram that illustrates the operation of an advantageous embodiment of the method of the present invention in which a chain of video-processing algorithms is optimized to obtain a high quality video signal.

### DETAILED DESCRIPTION OF THE INVENTION

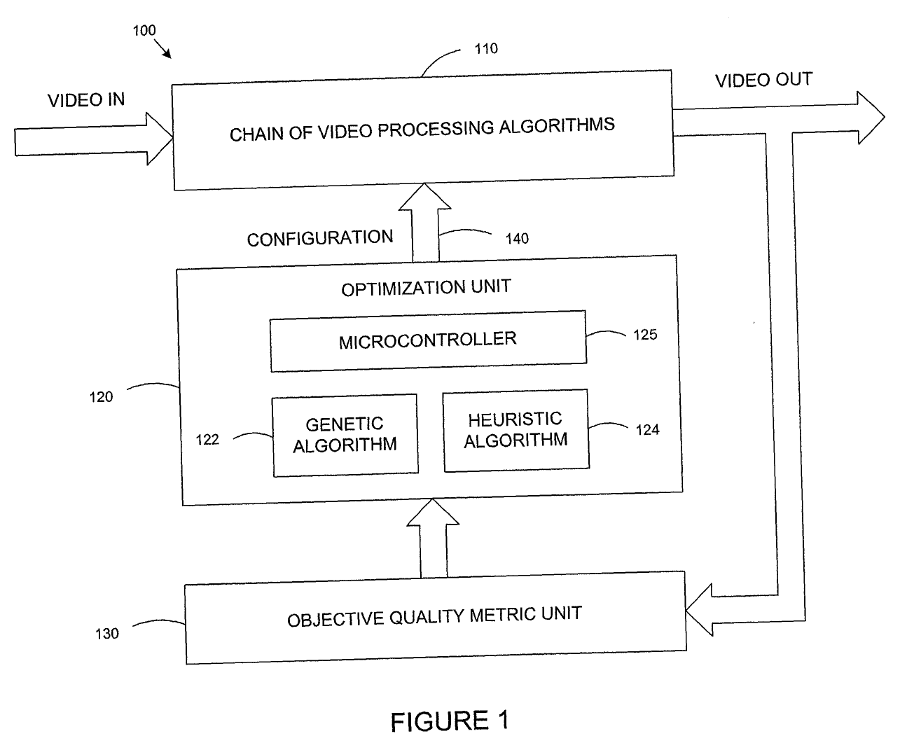

FIGS. 1 through 4, discussed below, and the various embodiments used to describe the principles of the present invention in this patent document are by way of illustration only and should not be construed in any way to limit the scope of the invention. In the description of the exemplary embodiment that follows, the present invention is integrated into, or is used in connection with, a video processing system. Those skilled in the art will recognize that the exemplary embodiment of the present invention may easily be modified for use in any type of video processing system.

FIG. 1 illustrates a block diagram of an exemplary video processing system 100 of the present invention for optimizing the control parameter settings in each video processing algorithm within a chain of video-processing algorithms. Video processing system 100 generally comprises a chain 110 of video-processing algorithms, optimization unit 120, and objective quality metric unit 130. An input video stream (labeled “Video In” in FIG. 1) is provided as input to chain 110. An output video stream (labeled “Video Out” in FIG. 1) is output from chain 110. A copy of the output video stream is fed back to objective quality metric unit 130.

Objective quality metric unit 130 provides a scalable dynamic objective metric for automatically evaluating video quality. Information concerning the details of the operation of objective quality metric unit 130 is set forth and described in U.S. patent application Ser. No. 09/734,823 filed Dec. 12, 2000 by Ali et al. entitled “System and Method for Providing a Scalable Dynamic Objective Metric for Automatic Video Quality Evaluation.”

The output of object quality metric unit 130 is provided as input to optimization unit 120. Optimization unit 120 configures the control parameter settings for each of the video-processing algorithms in chain 110. Optimization unit 120 may use different types of optimization techniques. A general description of these optimization techniques is provided in U.S. patent application Ser. No. 09/817,981 filed Mar. 27, 2001, by Ali, et al, entitled “System and Method for Optimizing Control Parameter Settings in a Chain of Video-processing algorithms”. An advantageous embodiment of optimization unit 120, for example, uses “genetic algorithm” optimization techniques. In the illustrated embodiment, optimization unit 120 includes genetic algorithm 122 and heuristic algorithm 124. Note that although referred to in the singular for convenience, there may be more than one genetic or heuristic algorithm present. Other algorithms may be present as well. In this embodiment, however, genetic algorithm 122 and heuristic algorithm 124 cooperate as directed by microcontroller 125 to achieve a solution quickly and efficiently, as described more fully below. First, however, each technique will be briefly described.

Genetic algorithm optimization techniques are based on the evolutionary concept that diversity helps to ensure a population's survival under changing environmental conditions. See, generally, “Genetic Algorithms in Search, Optimization, and Machine Learning” by David E. Goldberg, Addison-Wesley, Reading, Mass., 1989. Genetic algorithms are simple and robust methods for optimization and search. Genetic algorithms are iterative procedures that maintain a population of candidate solutions encoded in the form of chromosomes. The initial population of candidate solutions can be selected heuristically or randomly. A chromosome defines each candidate solution in a generation. For each generation, each candidate solution is evaluated and assigned a fitness value. The fitness value is generally a function of the decoded bits contained in each candidate solution's chromosome. These candidate solutions will be selected for reproduction in the next generation based on their fitness values. The fitness value in the present invention is provided by objective quality metric unit 130.

The selected candidate solutions are combined using a genetic recombination operation known as “crossover.” The crossover operator exchanges portions of bits of chromosomes to hopefully produce better candidate solutions with higher fitness for the next generation. A “mutation” is then applied to perturb the bits of chromosomes in order to guarantee that the probability of searching a particular subspace of the problem space is never zero. For more information, refer to the article entitled “Parallel Genetic Algorithms” by A. Chipperfield and P. Fleming on pages 1118-1143 of the book Parallel and Distributed Computing Handbook by A. Y. H. Zomaya, McGraw Hill, New York, 1996. The “mutation” also prevents the genetic algorithm from becoming trapped on local optima. See, generally, the article entitled “Genetic Algorithms in Optimization and Adaptation” by P. Husbands on pages 227-276 of the book Advances in Parallel Algorithms by L. Kronsjo and D. Shumsheruddin (editors), Blackwell Scientific, Boston, Mass., 1990.

The whole population of candidate solutions is evaluated again in the next generation and the process continues until the process reaches a threshold criterion. The threshold criterion may be met by reaching a predetermined level of convergence of the solution to the theoretical optimum. For example, the convergence level is continuously or periodically monitored to determine when a predetermined level of convergence is met.

Once the threshold criterion has been reached, a more computationally-efficient heuristic method is applied to the results. In this way, the optimizer more quickly reaches a local optima (which may or may not be the best overall solution). When a local optima is reached, genetic algorithms are applied, again until a determination that the threshold criterion has been met. This second threshold criterion may be the same as or different from the first.

The system and method of the present invention utilizes genetic algorithms to come up with choices for optimal control parameter settings for the video-processing algorithms. Genetic algorithms also provide implementation alternatives and provide an interconnection scheme for obtaining the best objective video quality. In optimizing the video processing scheme, a chromosome defines a certain way in which different video-processing algorithms are connected and, therefore, the way in which video sequences are processed. A chromosome consists of a number of genes. The genes in the video optimization process of the present invention comprise (1) video processing functions, and (2) the order of application of the video processing functions (which determines the connection scheme).

Heuristic algorithms often operate somewhat differently. Whereas a genetic algorithm uses a stochastic selection process to arrive at the best solution for the overall space, a heuristic method, for example “hill climbing”, simply chooses a starting point and repeatedly tests a next solution against a first, each time retaining the better solution. The solution quickly arrived at is better than all of its neighbor solutions, hence it is referred to as a local optima, but may not be the best overall. By analogy, a fog-bound hill-climber in the real world finds a high point by testing the terrain in each direction from a current location. If the directional step would result in moving up, the climber takes it. Although the climber will eventually arrive at a high point from which there is no upward step, there is no guarantee that this is the highest point in the entire search area.

In other words, while hill-climbing will quickly and efficiently converge on local optima, it may also get stuck there. Genetic algorithms do not have this detriment, but use vastly more time and computing resources. Note that unlike hill climbing, some heuristic methods will find a best solution instead of just the best local one, but the desired efficiency is often sacrificed in such processes.

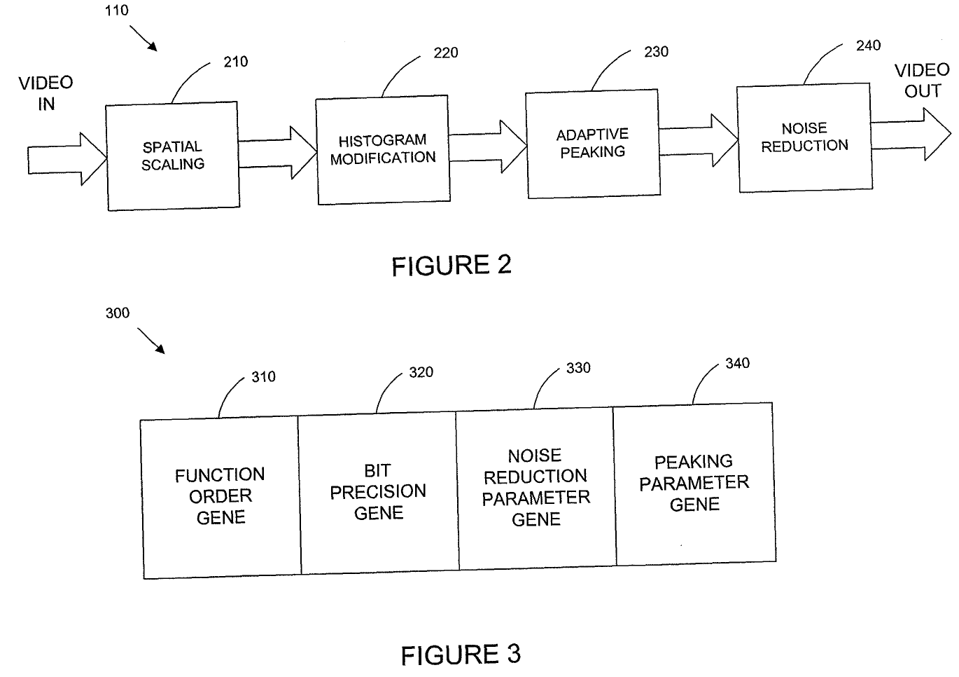

FIG. 2 illustrates a block diagram of an exemplary embodiment of video-processing algorithm chain 110. In this embodiment, chain 110 comprises four (4) such algorithms. The four video-processing algorithms are spatial scaling algorithm 210, histogram modification algorithm 220, adaptive peaking algorithm 230, and noise reduction algorithm 240. The present invention is not limited to an embodiment having four (4) video-processing algorithms. Chain 110 of video-processing algorithms may generally comprise any integer number of video-processing algorithms. As mentioned above, each of these video-processing algorithms includes a plurality of parameters, the optimal setting for which is a goal of the system and method of the present invention. There may, of course, be more than one such optimum. For example, a television set may use one set of parameters for one type of programming and another set for another type. Naturally, the system and method of the present invention may be used to find each set of parameters.

FIG. 3 illustrates a block diagram of a video processing chromosome 300 of the present invention. Chromosome 300 comprises function order gene 310, bit precision gene 320, noise reduction parameter gene 330, and peaking parameter gene 340. Each of the video-processing algorithms (210, 220, 230, 240) in chain 110 can be configured using the four (4) genes (310, 320, 330, 340) in chromosome 300. Specifically, the order of application of the video-processing algorithms can be changed, the control parameter settings of each video processing algorithm can be changed, and the bit precision of each video processing algorithm can be changed.

In a preferred embodiment of the present invention, optimization unit 120 uses a genetic algorithm optimization technique in cooperation with a heuristic search methodology to configure the control parameters of each of the video-processing algorithms (210, 220, 230, 240). The optimizer uses information located in the genes (310, 320, 330, 340) of chromosome 300. For example, peaking parameter gene 340 can be used to change the peaking (sharpness) control parameter for each of the four (4) video-processing algorithms. The process of configuring the video-processing algorithms is indicated schematically in FIG. 1 by arrow 140.

Optimization unit 120 configures each video processing algorithm as generically as possible. That is, optimization unit 120 assumes no prior information about a particular video processing algorithm or about its connectivity constraints (i.e., the order of the video-processing algorithms). Optimization unit 120 perturbs the pre-defined set of control parameters of each video processing algorithm in chain 110. The data bit precision (i.e., the number of bits in a data bus, or “bus width”) between two sequential video-processing algorithms is also a control parameter to be optimized.

Using the fitness value from objective quality metric unit 130, optimization unit 120 continually determines which configuration of control parameters (i.e., a candidate solution) should be tried next. The candidate solutions that provide good video images are retained while candidate solutions that provide poor video images are discarded. Driven by this “survival of the fittest” principle, expedited by incorporation of a heuristic algorithm, video processing system 100 iteratively converges toward control parameter configurations that produce the best high quality video image.

The genetic algorithm used by optimization unit 120 may be a variation of a standard genetic search algorithm. For additional information, refer to an article entitled “The CHC Adaptive Search Algorithm. How to Have Safe Search When Engaging in Nontraditional Genetic Recombination” by L. Eshelman on pages 265-283 of the book Foundations of Genetic Algorithms by G. Rawlins (editor), Morgan Kaufman Publishers, New York, 1991. The initial population of N chromosomes is generated randomly and each of the chromosomes is evaluated. An intermediate population is generated in the following fashion: (1) The current population is copied to the intermediate population. (2) Each chromosome in the current population is randomly paired with another chromosome. (3) Cross over is performed if the difference criterion is satisfied. (4) The user can specify the cross over criterion. (5) The resulting “children” are evaluated and added to the immediate population.

The resulting intermediate population has more than N chromosomes (2N if all the chromosomes pairs are different enough). The best N chromosomes from the intermediate population are selected and passed to the next generation. Note that no mutation is performed during this stage. Two chromosomes are crossed over only if the difference between them is above a threshold. This threshold is lowered when no chromosome pairs can be found with a difference above the threshold. When the threshold reaches zero (“0”), a re-initialization (or “divergence”) of the population is done. Here the best chromosome available is selected as a representative and copied over to the next generation. The rest of the chromosomes are generated by mutating a percentage of the bits (e.g., thirty five percent (35%)) of this template chromosome.

The particular set of video-processing algorithms shown in FIG. 2 was chosen as an illustrative example because of their vital role in any video processing system. Moreover, some of the video-processing algorithms shown in FIG. 2 have competing requirements. For example, (1) increasing the sharpness would enhance the perceived existing noise, and (2) reducing the noise will blur the picture resulting in the loss of image crispness.

As previously mentioned, video processing system 100 generally comprises chain 110 of video-processing algorithms, optimization unit 120, and objective quality metric unit 130. The computational bottleneck in video processing system 100 results from the complexity of the video-processing algorithms of chain 110. In order to reduce the computational requirements, it is possible to simultaneously run in parallel a number of chains of video-processing algorithms (depending on the available computation processors on a parallel computer). It is also possible to simultaneously run a number of objective quality metric units. The approach of using parallel units for the computationally greedy portions of video processing system 100 significantly enhances the overall performance that may be obtained.

It is noted that the possible combinations of control parameters present an enormous number of choices. For example, the relatively small chain of four (4) video-processing algorithms could generate as many as one hundred thousand (100,000) configurations. In order to effectively optimize the control parameter settings of the video-processing algorithms, the heuristic algorithm acts to effectively reduce the enormous search space to a manageable size.

In addition, is not necessary to consider each individual characteristic of each candidate solution in a whole breed of a generation. If the chromosome in question has a long sequence, then a thorough study of each individual candidate solution will be expensive. There will likely be a set of many very similar candidate solutions. The goal is to find and select “fit” individuals (i.e., candidate solutions that cause chain 110 to produce a high quality video signal). It is more efficient to select a limited number of representative individuals and study the representative individuals rather than study every individual in the whole generation.

It is also possible to delete an “unfit” branch of the “evolution” process according to the branch's inherited chromosome structure. In accordance with the probabilities of the “evolution” process, it is likely that a good “father” (an implementation that has a desired behavioral trait such as good subjective sharpness enhancement) will have a “son” that will inherit the same desired behavioral trait. That is, “fit” branches will be allowed to propagate and “unfit” branches will not be allowed to propagate.

Modifying the genetic algorithm using these guidelines will result in further reduction in the time required for the optimization process to converge to an optimal candidate solution.

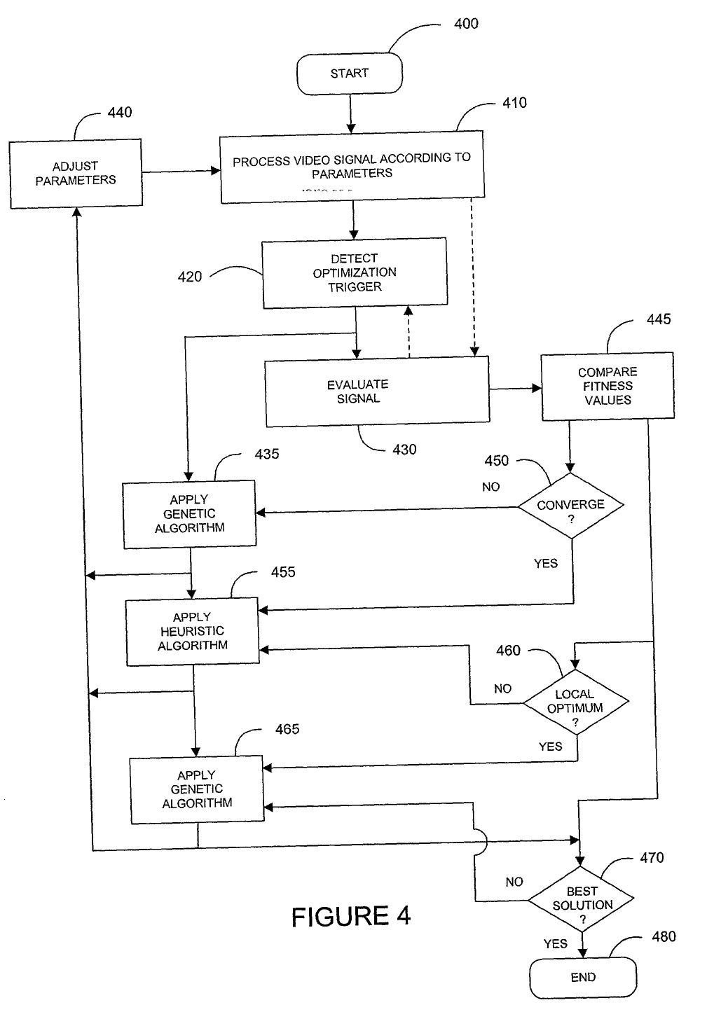

FIG. 4 depicts flow diagram 400 that illustrates the operation of exemplary video processing system 100 according to one advantageous embodiment of the present invention. Video processing system 100 receives a Video-In signal in chain 110 of video-processing algorithms and processes the video signal with video-processing algorithms (210, 220, 230, 240) (process step 410). This processing is done with whatever parameters are set, either as a default or as established by a previous optimization process. The processing may be on-line or off-line, that is, may be the video-signal stream being processed for display or an identical signal-stream that may be adjusted without affecting what the viewer actually sees. (The parameters affecting the display will be reset when optimized.)

The actual optimization process begins when triggered by some event (process step 420). This trigger may simply be a determination that the signal has not been optimized—ever, or for some set period of time, since the display has been powered-up, etc. The trigger may also be generated by a signal-monitoring function, if present. Note that the ‘trigger’ may also be viewed as a ‘flag’ indicating to the microcontroller 125 whether to execute the optimization routine. However it is initiated at process step 420, the processed (Video-out) signal is evaluated against an established metric (process step 430) by objective quality metric unit 130. The broken lines in FIG. 4 reflect an optional embodiment where signal evaluation step 430 actually generates the optimization trigger detected at process step 420. In either configuration, the signal evaluation results in a fitness value applicable to the quality of the video-out signal at the time it is evaluated.

When an optimization trigger is detected at step 420, microcontroller 125 applies genetic algorithm 122 to begin searching for the best parameter settings (process step 435). When a solution is reached, the parameters used by video-processing algorithms 210, 220, 230, and 240 are adjusted (process step 440). Video-signal processing (process step 410) then continues with these adjusted parameters. The resulting video-out signal is evaluated at process step 430. When more than one fitness value is generated, each is compared to the previous one or ones (process step 445). Microcontroller determines whether a solution is better than a previous one and, if so, determines by how much (determination step 450). (Less desirable solutions are simply noted but not further used (step not shown).) Specifically, a determination is made as to whether the improvement is an incremental increase that falls below a predetermined convergence value, for example an improvement of less than 20%. If not, application of the genetic algorithm continues. If so, microcontroller 125 directs that heuristic algorithm 124 be applied to the current best solution found by genetic algorithm 122 (process step 455). As the heuristic algorithm 122, such as a hill-climbing methodology, is applied, the parameters are adjusted (process step 440) and the video signal is processed (process step 410) and evaluated (process step 430).

While the heuristic algorithm is being applied, fitness values are compared (process step 445) and a determination is made as to whether a local optimum has been reached (determination step 460). If not, the heuristic search continues (process step 455). If so, microcontroller directs genetic algorithm 122 to continue searching using the local optimum found by heuristic algorithm 124 (process step 465). Note that process step preferably differs from process step 435 only in that the search space and perturbation methodology for genetic-algorithm application has been limited by the results of the heuristic-algorithm application. As described above, however, application of the genetic algorithm at process step 465 results in parameter adjustment (process step 440) and continued processing (process step 410) and signal evaluation (process step 430). At this point, however, fitness values are compared (process step 445) not only to determine if a predetermined convergence level is reached (determination step 450), but whether a best solution has been achieved (determination step 470), that is, that the parameters are considered optimized. If the video signal has been optimized, then the process ends (480).

If the video signal has not been optimized, then control returns to process step 465. The determination of whether the video signal has in fact been optimized may be made by any acceptable criteria, including a manually input user request, and may take into account, for example, a change in the character or quality of the programming (or other video presentation) being displayed. For example, if a certain threshold number of candidate solutions fail to produce an improvement, or if a certain amount of time elapses without measurable progress, the video signal may be considered optimized until the next optimization-initiation event, or trigger. If the optimization has been performed off-line, then the actual parameters may now be set to the optimized values found in the process described above. Finally, note that the best solution may well not result from only a single application of heuristic algorithm 124. More likely, it will be applied (process step 455) many times and provide a plurality of local optima for use in applying the genetic algorithm 122 at process step 455.

Therefore, the system and method of the present invention comprises an improved video processing system 100 that is capable of optimizing the control parameter settings of a chain 110 of video-processing algorithms (210, 220, 230, 240). This system and method invention uses a genetic algorithm 122 and a heuristic algorithm 124 in cooperation to iteratively converge the values of the control parameter settings toward a configuration of control parameter settings that produces a very high quality video image.

Although the present invention has been described in detail, those skilled in the art should understand that they can make various changes, substitutions and alterations herein without departing from the spirit and scope of the invention in its broadest form.

What is claimed is:

1. For use in a video processing system of the type comprising a chain of video-processing algorithms for processing a video stream, a system for optimizing at least one control parameter setting of at least one of said video-processing algorithms in said chain of video-processing algorithms, said system comprising:
an optimization unit comprising a plurality of algorithms, said algorithms including at least a genetic algorithm and a heuristic algorithm, for optimizing said at least one control parameter setting of said at least one video processing algorithm by applying the heuristic algorithm to a result produced by the genetic algorithm.

2. The system as claimed in claim 1 further comprising an objective quality metric unit coupled to said optimization unit, said objective quality metric unit capable of receiving an output video stream from said chain of video-processing algorithms, and capable of determining a fitness value that characterizes the video quality of said output video stream, and capable of providing said fitness value to said optimization unit.

3. The system as claimed in claim 2 wherein said algorithms in said optimization unit optimize said at least one control parameter setting of said at least one video processing algorithm using said fitness value.

4. The system as claimed in claim 1 wherein said optimization unit comprises an algorithm that is capable of optimizing a plurality of control parameter settings of each of a plurality of video-processing algorithms in said chain of video-processing algorithms.

5. The system as claimed in claim 4 further comprising an objective quality metric unit coupled to said optimization unit, said objective quality metric unit capable of receiving an output video stream from said chain of video-processing algorithms, and capable of determining a fitness value that characterizes the video quality of said output video stream, and capable of providing said fitness value to said optimization unit.

6. For use in a video processing system of the type comprising a chain of video-processing algorithms for processing a video stream, an optimizer for optimizing at least one control parameter setting of at least one of said video-processing algorithms in said chain of video-processing algorithms, said optimizer comprising:
a genetic algorithm unit comprising a genetic algorithm capable of optimizing said at least one control parameter setting of said at least one video processing algorithm;
a convergence monitoring unit for determining the convergence level achieved by the genetic algorithm unit;
a heuristic algorithm unit comprising a heuristic algorithm for receiving a result from the genetic algorithm search unit and searching for a best local solution when the convergence monitoring unit has determined that the genetic algorithm has reached a predetermined convergence level.

7. The optimizer as claimed in claim 6 further comprising an objective quality metric unit coupled to said genetic algorithm unit and said heuristic algorithm unit, said objective quality metric unit capable of receiving an output video stream from said chain of video-processing algorithms, and capable of determining a fitness value that characterizes the video quality of said output video stream, and capable of providing said fitness value to said genetic algorithm in said genetic algorithm unit and said heuristic algorithm in said heuristic algorithm unit.

8. The optimizer as claimed in claim 7 wherein said genetic algorithm in said genetic algorithm unit and said heuristic algorithm in said heuristic algorithm unit optimize said at least one control parameter setting of said at least one video processing algorithm using said fitness value.

9. The optimizer as claimed in claim 6 wherein said optimizer is capable of optimizing a plurality of control parameter settings of each of a plurality of video-processing algorithms in said chain of video-processing algorithms.

10. The optimizer as claimed in claim 9 further comprising an objective quality metric unit coupled to said genetic algorithm unit and said heuristic algorithm unit, said objective quality metric unit capable of receiving an output video stream from said chain of video-processing algorithms, and capable of determining a fitness value that characterizes the video quality of said output video stream, and capable of providing said fitness value to said genetic algorithm and said heuristic algorithm.

11. The optimizer as claimed in claim 10 wherein said genetic algorithm in said genetic algorithm unit and said heuristic algorithm in said heuristic algorithm unit optimize a plurality of control parameter settings of a plurality of said video-processing algorithms using said fitness value.

12. The optimizer as claimed in claim 11 wherein at least one of said plurality of control parameter settings comprises the order of application of said video-processing algorithms in said chain of video-processing algorithms.

13. The optimizer as claimed in claim 11 wherein at least one of said plurality of control parameter settings of said video-processing algorithms comprises one of: a bit precision parameter, a noise reduction parameter, and a peaking parameter.

14. For use in a video processing system of the type comprising a plurality of chains of video-processing algorithms for processing a plurality of video streams, a system for optimizing a plurality of control parameter settings of a plurality of video-processing algorithms in said plurality of chains of videoprocessing algorithms, said system comprising:
a plurality of optimization units coupled to said plurality of parallel chains of video-processing algorithms, each of said plurality of optimization units comprising a genetic algorithm and a heuristic algorithm capable of cooperating to optimize said plurality of control parameter settings of said plurality of chains of video-processing algorithms; and
a plurality of objective quality metric units, each of said plurality of objective quality metric units coupled to one of said plurality of optimization units, each of said plurality of objective quality metrics capable of receiving an output video stream from one of said plurality of chains of video-processing algorithms, and capable of determining a fitness value that characterizes the video quality of said output video stream, and capable of providing said fitness value to the optimization unit to which said objective quality metric unit is coupled;
wherein said optimization units optimize a plurality of control parameter settings of said plurality of video-processing algorithms using said fitness values.

15. The system as claimed in claim 14 comprising a genetic algorithm in which candidate solutions that will not provide an improvement in video quality are excluded.

16. The system as claimed in claim 14 comprising a genetic algorithm in which a limited number of representative candidate solutions that are likely to provide an improvement in video quality are considered.

17. The system as claimed in claim 14 comprising a genetic algorithm in which candidate solutions are considered that derive from previously existing desirable candidate solutions that are likely to provide an improvement in video quality.

18. For use in a video processing system of the type comprising a chain of video-processing algorithms for processing a video stream, a method for optimizing at least one control parameter setting of at least one of said video-processing algorithms in said chain of video-processing algorithms, said method comprising the steps of:
using a genetic algorithm in an optimization unit to search for optimum solutions for said at least one control parameter setting of said at least one of said video-processing algorithms;
determining that said genetic algorithm has reached a pre-determined level of convergence;
using a heuristic algorithm in said optimization unit to search for local optima upon determining that the genetic algorithm has reached said pre-determined level of convergence.

19. The method as claimed in claim 18 further comprising the step of applying said genetic algorithm in said optimization unit to a heuristic algorithm search result.

20. The method as claimed in claim 19 further comprising the steps of:
receiving an output video stream from said chain of video-processing algorithms in an objective quality metric unit;
determining in said objective quality metric unit a fitness value for said output video stream;
providing said fitness value to said optimization unit; and
using said fitness value in said optimization unit.

21. The method as claimed in claim 19 wherein said optimization unit is capable of optimizing a plurality of control parameter settings of each of a plurality of video-processing algorithms in said chain of video-processing algorithms.

22. The method as claimed in claim 21 further comprising the steps of:
receiving an output video stream from said chain of video-processing algorithms in an objective quality metric unit;
determining in said objective quality metric unit a fitness value for said output video stream;
providing said fitness value to said optimization unit; and
using said fitness value in said optimization unit.

23. The method as claimed in claim 22 wherein at least one of said plurality of control parameter settings comprises the order of application of said video-processing algorithms in said chain of video-processing algorithms.

24. The method as claimed in claim 22 wherein at least one of said plurality of control parameter settings of said video-processing algorithms comprises one of: a bit precision parameter, a noise reduction parameter, and a peaking parameter.

25. A signal for generating a video display on a video display unit, wherein said signal is produced by a chain of video-processing algorithms processing a received video signal, the chain of video-processing algorithms including a plurality of parameters, wherein the parameters are optimized by an optimization unit having a genetic algorithm and a heuristic algorithm.

26. The signal of claim 25, wherein the optimization unit optimizes said parameters by using the genetic algorithm to search the search space until a predetermined convergence level is detected, whereupon said heuristic algorithm is directed to reach a locally optimum solution.

27. The signal of claim 26, wherein the optimization unit comprises a microcontroller for directing application of said heuristic algorithm.

28. The signal of claim 26, wherein the genetic algorithm is directed to resume searching the search space using the local optimum found by said heuristic algorithm as a candidate solution.

29. The signal of claim 26, wherein said heuristic algorithm is a hill-climbing algorithm.
